(19) United States
(12) Patent Application Publication
(10) Pub. No.: US 2008/0084691 A1
(43) Pub. Date: Apr. 10, 2008

(54) Light device with a color mixing effect

(75) Inventors: Yu-Nan Liu, Kaohsiung (TW); Chao-Fang Chung, Pingtung (TW); Tzu-Wei Wang, Taoyuan (TW); Ching-Ching Chen, Kaohsiung (TW); Wen-Hsien Hsieh, Taipei (TW); Tzeng-Guang Tsai, Hsinchu (TW)

Correspondence Address: BACON & THOMAS, PLLC, 625 SLATERS LANE, FOURTH FLOOR, ALEXANDRIA, VA, 22314, US

(73) Assignee: Lite-On Technology Corp.

(21) Appl. No.: 11/798,268

(22) Filed: May 11, 2007

(30) Foreign Application Priority Data
Oct. 4, 2006 (TW) 95136957

(51) Int. Cl. F21V 99/00

(52) U.S. Cl. 362/231

(57) ABSTRACT

A light device with a color mixing effect, includes a first light bar, a second light bar, and a holding structure. The first light bar emits a first color light with a first color, and the second light bar emits a second color light with a second color different from the first color. The holding structure, having a light-mixing area, includes a first positioning portion and a second positioning portion. The first positioning portion is for positioning the first light bar, the second positioning portion is for positioning the second light bar, and the first light bar is parallel to and obliquely faces the second light bar, such that the first color light and the second color light are respectively emitted into the light-mixing area to form a third color light with a third color different from the first color and the second color.

This application claims the benefit of Taiwan application Serial No. 95136957, filed Oct. 4, 2006, the subject matter of which is incorporated herein by reference.

### BACKGROUND OF THE INVENTION

1. Field of the Invention

The invention relates in general to a light device, and more particularly to a light device with a color mixing effect.

2. Description of the Related Art

Light emitting diode (LED), a light emitting element made from semiconductor material, possesses the advantages of small volume, long lifespan, low driving voltage, low power consumption and strong shock-resistance. LED backlight source has been widely used in electronic products such as mobile phone, notebook, personal digital assistant (PDA), LCD monitor, car TV, and LCD TV. A single LED chip, having narrow frequency spectrum, is unable to emit a white light. Therefore, some skills are required to generate a white light. For example, a red light LED, a green light LED and a blue light LED are mixed to form a white light.

Referring to FIG. 1, a perspective view of a conventional LED light source is shown. According to the current method of mixing the light by an LED light source, a red light LED chip 102, a green light LED chip 104 and a blue light LED chip 106 are packaged together to form a multi-chip LED package 100. By using a lens 110 of the multi-chip LED package 100 to focus the light, color mixing effect is generated at a light-mixing distance of approximately 5 mm. As indicated in FIG. 1, the conventional LED light source uses a number of multi-chip LED packages 100 to form a white LED light bar 10. However, the packaging process of the multi-chip LED package 100 is complicated and the associated heat dissipation is a difficult problem to tackle with. According to the conventional practice, three LED chips are packaged together, resulting in a package much larger than the single LED chip. Furthermore, as the decay of the red light LED chip 102 is faster than the green light LED chip 104 and the blue light LED chip 106, the green light LED chip 104 and the blue light LED chip 106 are not fully utilized.

### SUMMARY OF THE INVENTION

The invention is directed to a light device with a color mixing effect, using a mechanical design to achieve the color mixing effect of the LED light sources. The luminance and the color saturation of the LED light sources are enhanced, and the heat generated in the LED light sources is effectively dissipated.

According to a first aspect of the present invention, a light device including a first light bar, a second light bar, and a holding structure is provided. The first light bar emits a first color light with a first color, and the second light bar emits a second color light with a second color different from the first color. The holding structure, having a light-mixing area, includes a first positioning portion and a second positioning portion adjacent to the first positioning portion. The first positioning portion is for positioning the first light bar, the second positioning portion is for positioning the second light bar, and the first light bar is parallel to and obliquely faces the second light bar, such that the first color light and the second color light are respectively emitted into the light-mixing area to form a third color light with a third color different from the first color and the second color.

According to a second aspect of the present invention, a light device including a linear light source is provided. The linear light source includes a red light bar, a green light bar, a blue light bar, and a holding structure. The red light bar emits a red light; the green light bar emits a green light; the blue light bar emits a blue light. The holding structure having a light-mixing area includes a first positioning portion, a second positioning portion, and a third positioning portion. The second positioning portion is adjacent to the first positioning portion, and the third positioning portion is adjacent to the second positioning portion. The first positioning portion is for positioning the red light bar, the second positioning portion is for positioning the green light bar, the third positioning portion is for positioning the blue light bar, and the red light bar, the green light bar, and the blue light bar are disposed in parallel and obliquely face each other in pair, such that the red light, the green light, and the blue light are emitted into the light-mixing area to form a white light.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a perspective view of a conventional LED light source;

FIG. 2 is a side view of a light device according to a first embodiment of the invention;

FIG. 3A is a perspective view of the holding structure in FIG. 2A;

FIG. 3B is a perspective view of another holding structure;

FIG. 4A is a front view of the light device in FIG. 2 with aligned LEDs;

FIG. 4B is a front view of the light device in FIG. 2 with alternated LEDs;

FIG. 5A is a front view of a light device according to a second embodiment of the invention;

FIG. 5B is a side view of the light device in FIG. 5A;

FIG. 6 is a front view of a light device according to a third embodiment of the invention; and

FIG. 7 shows the light device in FIG. 2 used as a backlight source of a side-type backlight module.

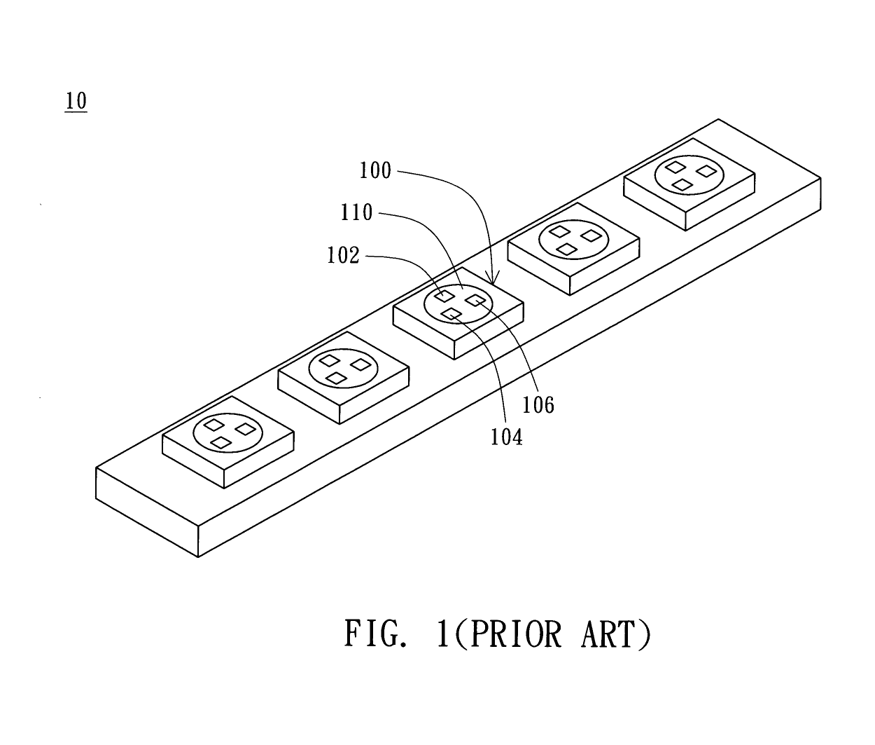

### DETAILED DESCRIPTION OF THE INVENTION

In the following embodiments of the invention, a holding structure is used for positioning at least two light bars whose color lights have different colors, such that the light bars are parallel to and obliquely faces each other, and the lights with different colors are emitted into the light-mixing area to form a color-mixing light. A light device, which mixes three lights with three colors including the red light, the green light, and the blue light to form a white light, is exemplified below.

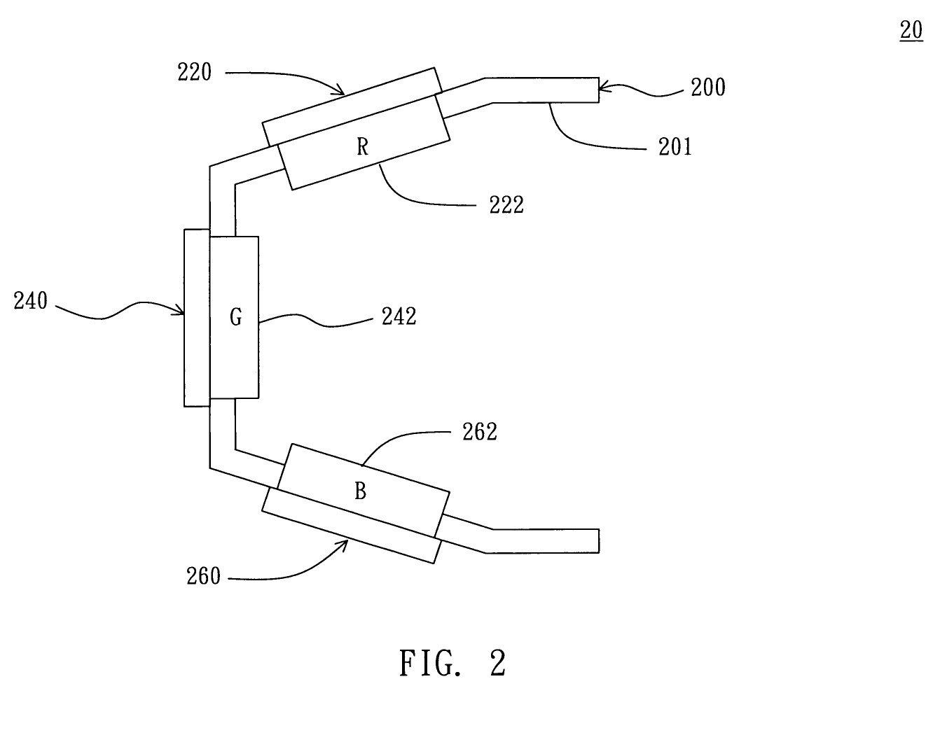

Referring to FIG. 2, a side view of a light device according to a first embodiment of the invention is shown. The light device 20 includes a red light bar 220, a green light bar 240, a blue light bar 260, and a holding structure 200. The holding structure 200 includes a first positioning portion, a second positioning portion, and a third positioning portion. The second positioning portion is adjacent to the first positioning portion, and the third positioning portion is adjacent to the second positioning portion. The first positioning portion is for positioning the red light bar 220, the second positioning portion is for positioning the green light bar 240, and the third positioning portion is for positioning the blue light bar 260, such that the red light bar 220, the green light bar 240, and the blue light bar 260 are disposed in parallel and obliquely face each other in pair.

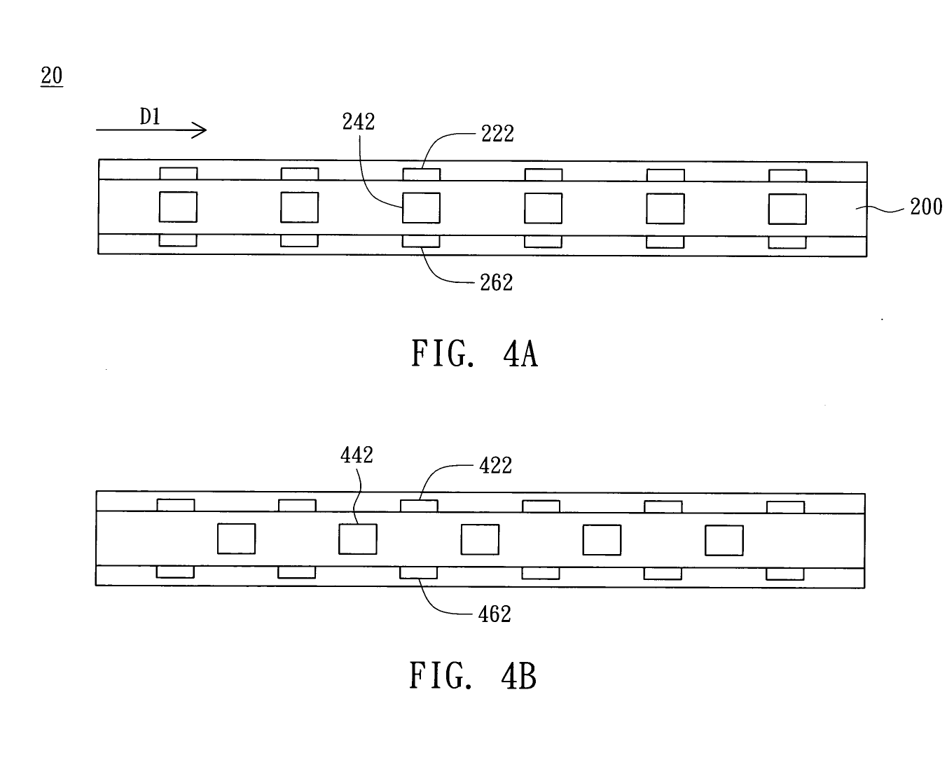

Referring to FIG. 2, FIGS. 4A and 4B, preferably, the red light bar 220 includes a number of red light emitting diodes (LEDs) 222 extended along a first direction D1 in equal distance. The green light bar 240 includes a number of green light LEDs 242 extended along the first direction D1 in equal distance. The blue light bar 260 includes a number of blue light LEDs 262 extended along the first direction D1 in equal distance. As the red light, the green light, and the blue light are mixed to form a white light, the light device of the first embodiment is a white light bar extended along the first direction. Furthermore, the arrangement of every two different colored LEDs of the red light LED 222, the green light LED 242, and the blue light LED 262 can be aligned or alternated. As indicated in FIG. 4A, each red light LED 222 is aligned with the neighboring green light LED 242, and each green light LED 242 is aligned with the neighboring blue light LED 262, such that the red light LED 222, the green light LED 242, and the blue light LED 262 are aligned. As indicated in FIG. 4B, each green light LED 442 is positioned between two adjacent red light LEDs 422 and between two adjacent blue light LEDs 462, such that the red light LED 422, the green light LED 442, and the blue light LED 462 are alternated.

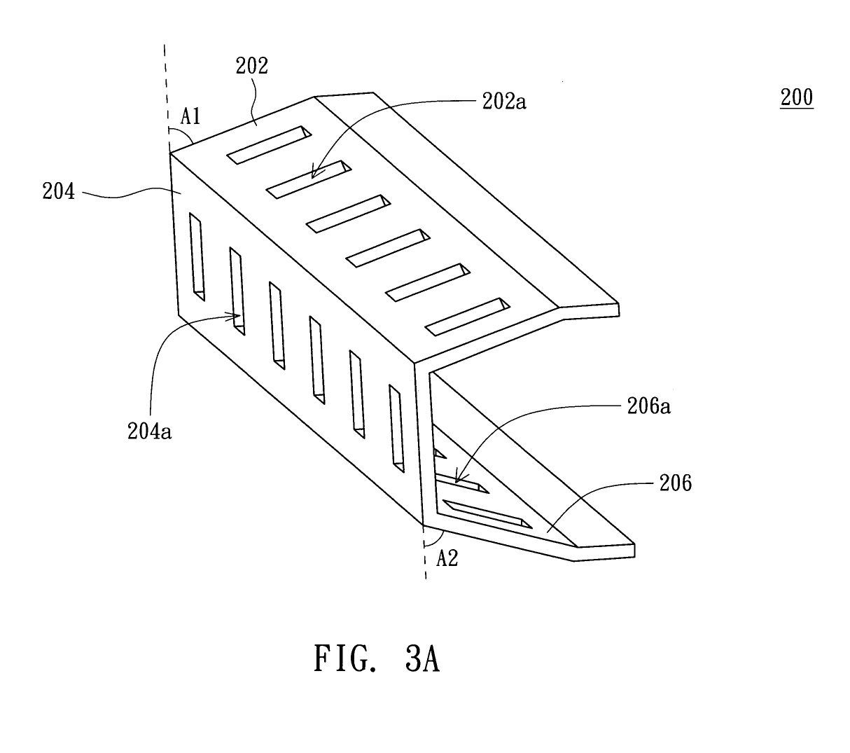

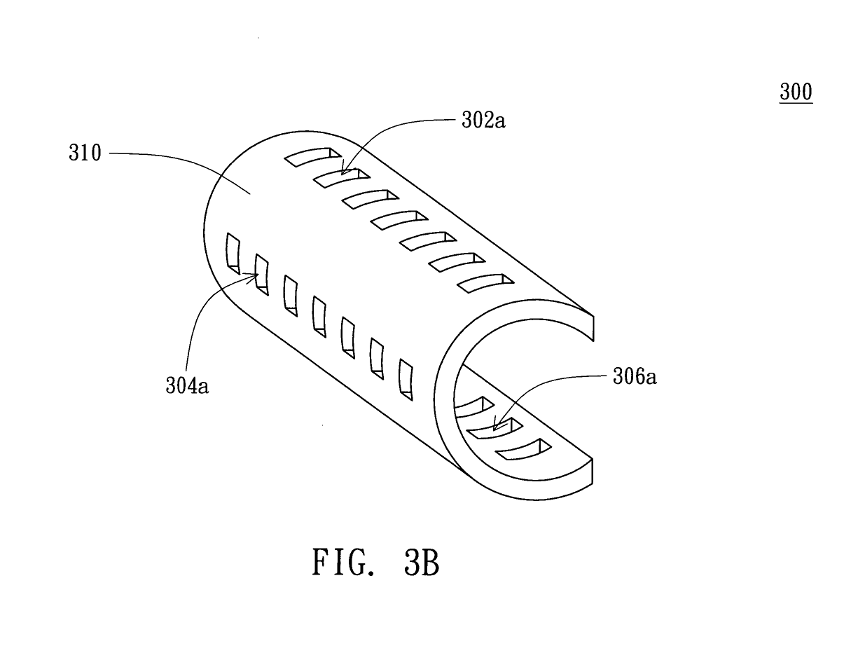

Referring to both FIG. 2 and FIG. 3A, FIG. 3A is a perspective view of the holding structure in FIG. 2. As indicated in FIG. 3A, the first positioning portion preferably has a number of first positioning holes 202a correspondingly engaged with a number of red light LEDs 222; the second positioning portion 204 preferably has a number of second positioning holes 204a correspondingly engaged with a number of green light LEDs 242; the third positioning portion 206 preferably has a number of third positioning holes 206a correspondingly engaged with a number of blue light LEDs 262. The holding structure 200 in FIG. 3A is a multi-angled structure and includes a first positioning piece 202, a second positioning piece 204, and a third positioning piece 206. The holding structure 200 has a light-mixing area positioned among the first positioning piece 202, the second positioning piece 204, and the third positioning piece 206. That is, the light-mixing area is enclosed by the first positioning piece 202, the second positioning piece 204, and the third positioning piece 206. The holding structure 200 further has a reflective surface 201 for reflecting the light to the light-mixing area. As indicated in FIG. 3A, the first positioning piece 202 and the second positioning piece 204 are connected to each other and have a first adjustable included angle A1; the second positioning piece 204 and the third positioning piece 206 are connected to each other and have a second adjustable included angle A2. The dimension of the first adjustable included angle A1 and the dimension of the second adjustable included angle A2 are adjusted according to the purposes, such that the area of the light-mixing area and the intensity of the light are adjusted accordingly. The larger the included angle is, the smaller the light-mixing area and the stronger the intensity of the light will be. The smaller the included angle is, the larger the area of the light-mixing area and the weaker the intensity of the light will be.

Referring to FIG. 3B, a perspective view of another holding structure is shown. The holding structure 300 in FIG. 3B is a curved sheet structure and includes a curved positioning piece 310 and a number of first positioning holes 302a, second positioning holes 304a, and third positioning holes 306a correspondingly engaged with a number of red light LEDs 222, green light LEDs 242, and blue light LEDs 262 of FIG. 2, respectively. The light-mixing area of the holding structure 300 is an area enclosed by the curved sheet structure. As indicated in FIG. 3B, the curvature of the curved sheet structure is adjusted according to the purposes, such that the area of he light-mixing area and the intensity of the light are adjusted accordingly.

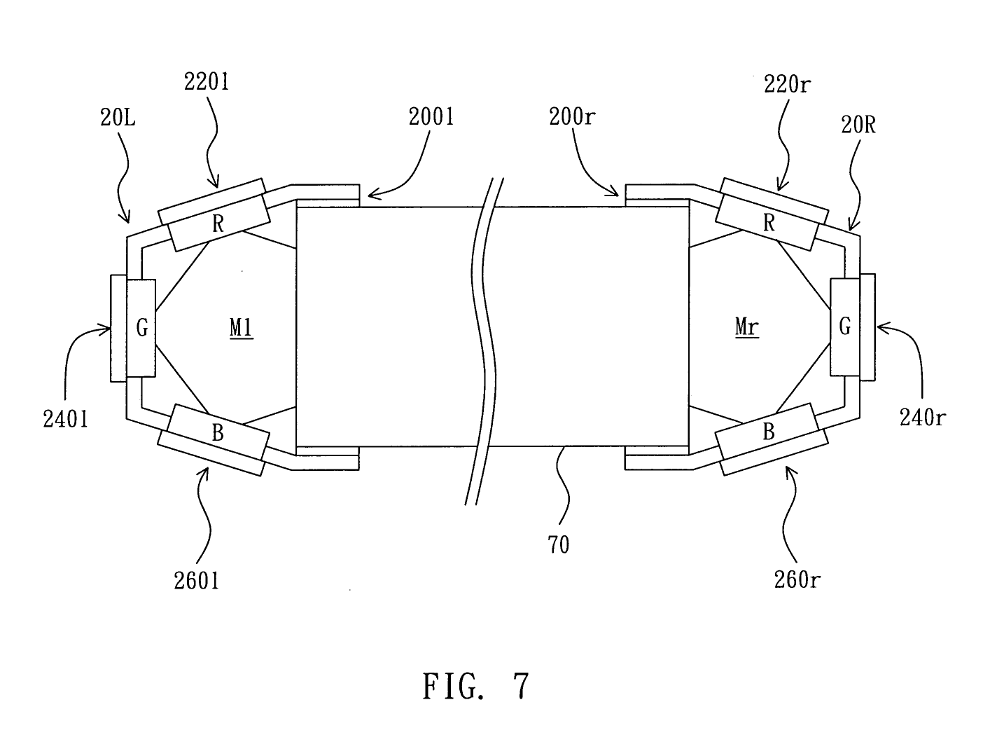

Referring to FIG. 7, FIG. 7 shows the light device in FIG. 2 used as a backlight source of a side-type backlight module is shown. The backlight source of a side-type backlight module is disposed at two lateral sides of the light-guiding plate. As indicated in FIG. 7, the light device 20L and the light device 20R are respectively disposed at two lateral sides of the light-guiding plate 70. The holding structure 200I of the light device 20L has a light-mixing area Ml, and the structural design of the holding structure is multi-angled, such that the red light bar 220I, the green light bar 240I, and the blue light bar 260I obliquely face each other in pair. When the red light bar 220I, the green light bar 240I, and the blue light bar 260I respectively emit a red light, a green light, and a blue light at the same time, the red light, the green light, and the blue light are respectively emitted into the light-mixing area Ml to form a white light. Likewise, the holding structure 200r of the light device 20R has a light-mixing area Mr, and the structural design of the holding structure is multi-angled, such that the red light bar 220r, the green light bar 240r, and the blue light bar 260r obliquely face each other in pair. When the red light bar 220r, the green light bar 240r, and the blue light bar 260r respectively emit a red light, a green light, and a blue light at the same time, the red light, the green light, and the blue light are respectively emitted into the light-mixing area Mr to form a white light. Thus, the white light generated by the light device 20L and the white light generated by the light device 20R are respectively emitted into the light-guiding plate 70 from two lateral sides of the light-guiding plate 70, spread evenly and emitted out from the surface of the light-guiding plate 70.

The light device of the first embodiment forms a white light bar extended along a first direction D1. The light device of the second embodiment and the light device of the third embodiment are composed of several white light bars, and the white planar light source formed thereby can be used as a backlight source of the direct-type backlight module. Besides, the number and arrangement of the white light bars are determined according to the size of the panel.

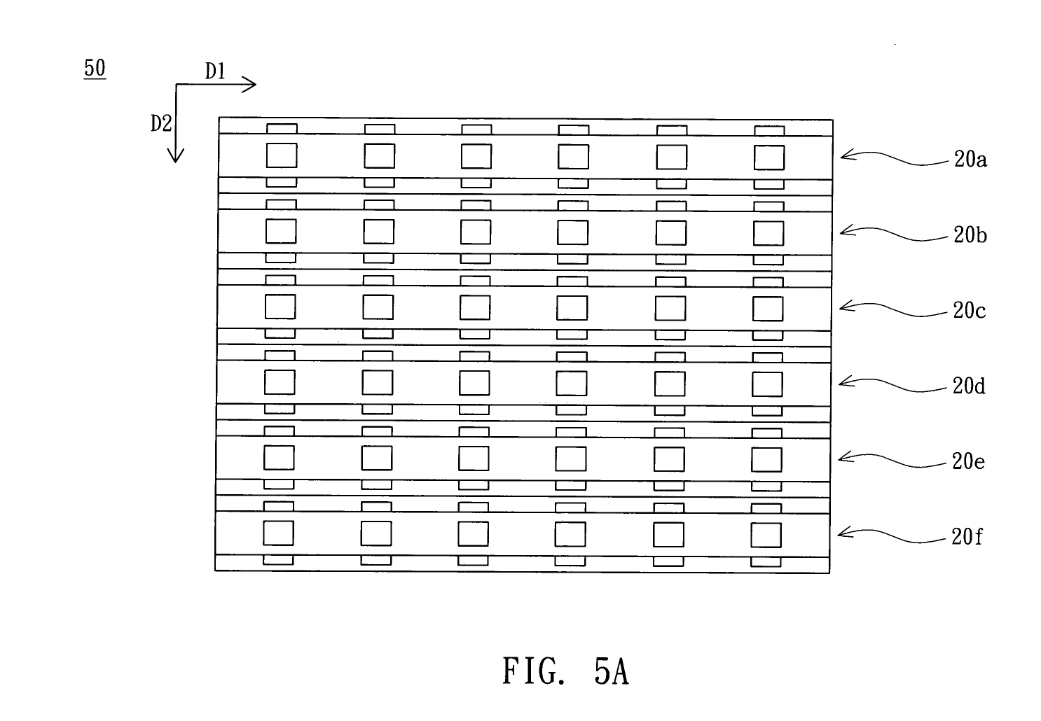

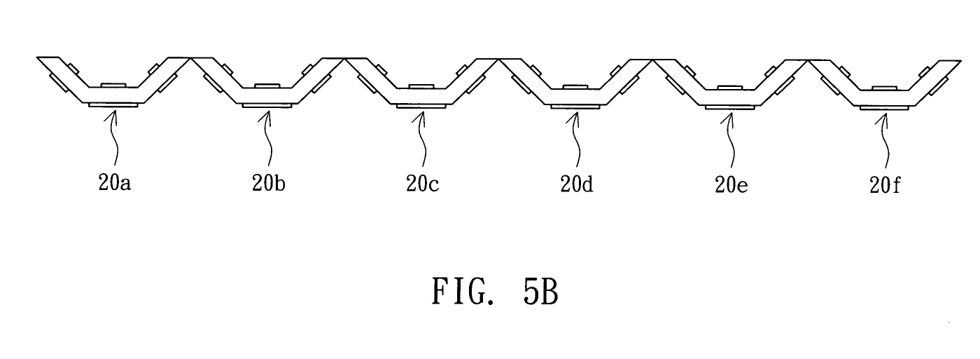

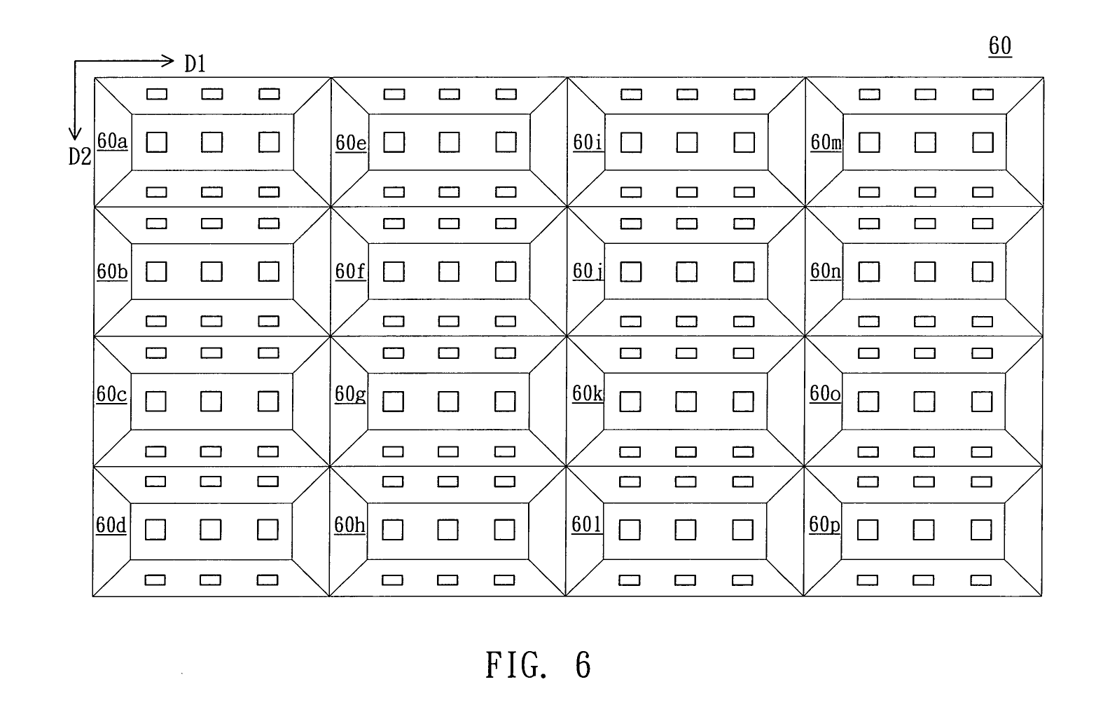

Referring to both FIG. 5A and FIG. 5B, the light device of the second embodiment includes a number of white light bars 20a, 20b, 20c, 20d, 20e and 20f extended along the first direction D1. The white light bars 20a-f are arranged in parallel along a second direction D2 perpendicular to the first direction D1 and are mixed to compose the light device of the second embodiment to form a white planar light source. As indicated in FIG. 5B, several holding structures are arranged in parallel along a second direction to form a wave structure. Referring to FIG. 6, the light device of the third embodiment includes a number of white light bars 60a, 60b, 60c, 60d, 60e, 60f, 60g, 60h, 60i, 60j, 60k, 60l, 60m, 60n, 60o, and 60p extended along the first direction D1. The white light bars 60a-p are arranged in parallel along the first direction D1 and aligned in a second direction D2 perpendicular to the first direction D1 to compose the light device of the third embodiment so as to form another white planar light source. As indicated in FIG. 6, several holding structures are arranged in parallel along the first direction and the second direction to form a beehive structure.

According to the light device disclosed in the above embodiments of the invention, the holding structure has a multi-angled or curved design, such that the red light, the green light, and the blue light bar are disposed in parallel and obliquely face each other in pair to form a white light bar, thereby enabling the LED light source to achieve the color mixing effect. Furthermore, the invention replaces the conventional design of packaging three LED chips together by a structural design, not only significantly improving heat dissipation, but also saving power consumption due to the absence of light-mixing distance. According to the structural design of the invention, the currents of the three LEDs are separately controlled. Thus, respective currents are provided according to the needs of the red light LED, the green light LED, and the blue light LED. Moreover, by controlling the respective currents provided to the red light LED, the green light LED and the blue light LED, backlight sources with different luminance levels or different colors can be provided, hence increasing the luminance efficiency and color saturation of LED light sources.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light device, comprising:
a first light bar for emitting a first color light with a first color;
a second light bar for emitting a second color light with a second color different from the first color; and
a holding structure, having a light-mixing area, comprising:
a first positioning portion for positioning the first light bar; and
a second positioning portion adjacent to the first positioning portion for positioning the second light bar, wherein the first light bar is parallel to and obliquely faces the second light bar, such that the first color light and the second color light are emitted into the light-mixing area to form a third color light with a third color different from the first color and the second color.

2. The light device according to claim 1, wherein the first light bar comprises a plurality of first light emitting diodes (LEDs), and the second light bar comprises a plurality of second LEDs.

3. The light device according to claim 2, wherein the first LEDs and the second LEDs are aligned.

4. The light device according to claim 2, wherein the first LEDs and the second LEDs are alternated.

5. The light device according to claim 2, wherein the first positioning portion has a plurality of first positioning holes correspondingly engaged with the first LEDs, and the second positioning portion has a plurality of second positioning holes correspondingly engaged with the second LEDs.

6. The light device according to claim 1, wherein the holding structure is a multi-angled sheet structure.

7. The light device according to claim 6, wherein the multi-angled sheet structure comprises two positioning pieces connected to each other, and the two connected positioning pieces have an adjustable included angle.

8. The light device according to claim 7, wherein the light-mixing area is positioned between the two connected positioning pieces.

9. The light device according to claim 1, wherein the holding structure is a curved sheet structure.

10. The light device according to claim 1, wherein the holding structure has a reflective surface for reflecting the first color light, the second color light and the third color light to the light-mixing area.

11. A light device, comprising:
a white light bar, comprising:
a red light bar for emitting a red light;
a green light bar for emitting a green light; and
a blue light bar for emitting a blue light; and
a holding structure, having a light-mixing area, comprising:
a first positioning portion for positioning the red light bar;
a second positioning portion adjacent to the first positioning portion for positioning the green light bar; and
a third positioning portion adjacent to the second positioning portion for positioning the blue light bar, wherein the red light bar, the green light bar, and the blue light bar are disposed in parallel and obliquely face each other in pair, such that the red light, the green light, and the blue light are respectively emitted into the light-mixing area to form a white light.

12. The light device according to claim 11, wherein the red light bar comprises a plurality of red LEDs, the green light bar comprises a plurality of green light LEDs, and the blue light bar comprises a plurality of blue light LEDs.

13. The light device according to claim 12, wherein the red light LEDs, the green light LEDs, and the blue light LEDs are aligned.

14. The light device according to claim 12, wherein the red light LEDs, the green light LEDs, and the blue light LEDs are alternated.

15. The light device according to claim 12, wherein the first positioning portion has a plurality of first positioning hole correspondingly engaged with the red light LEDs, the second positioning portion has a plurality of second positioning hole correspondingly engaged with the green light LEDs, and the third positioning portion has a plurality of the third positioning hole correspondingly engaged with the blue light LEDs.

16. The light device according to claim 11, wherein the holding structure is a multi-angled sheet structure.

17. The light device according to claim 16, wherein the multi-angled sheet structure comprises a first positioning piece, a second positioning piece, and a third positioning piece, the first positioning piece and the second positioning piece are connected and have a first adjustable included angle, and the second positioning piece and the third positioning piece are connected and have a second adjustable included angle.

18. The light device according to claim 17, wherein the light-mixing area is positioned among the first positioning piece, the second positioning piece, and the third positioning piece.

19. The light device according to claim 11, wherein the holding structure is a curved sheet structure.

20. The light device according to claim 11, wherein the holding structure has a reflective surface for reflecting the light to the light-mixing area.

21. The light device according to claim 11, wherein the white light bar is extended along a first direction, the light device comprises a plurality of the white light bars arranged in parallel along a second direction to form a white planar light source, the second direction is perpendicular to the first direction.

22. The light device according to claim 21, wherein the light device comprises a plurality of the holding structures, the holding structures form a wave structure.

23. The light device according to claim 11, wherein the white light bar is extended along a first direction, the light device comprises a plurality of white light bars arranged in parallel along the first direction and aligned in a second direction to form a white planar light source, the second direction is perpendicular to the first direction.

24. The light device according to claim 23, wherein the light device comprises a plurality of the holding structures, the holding structures form a beehive structure.
